(19) United States
(12) Patent Application Publication
(10) Pub. No.: US 2016/0353785 A1
(43) Pub. Date: Dec. 8, 2016

(54) Pulsed Light Treatment System with Rotary Light Table

(71) Applicant: Cougar Packaging Concepts, Inc., West Chicago, IL (US)

(72) Inventor: Mark A. Cottone, West Chicago, IL (US)

(73) Assignee: Cougar Packaging Concepts, Inc., West Chicago, IL (US)

(21) Appl. No.: 15/153,160

(22) Filed: May 12, 2016

Related U.S. Application Data
(60) Provisional application No. 62/161,625, filed on May 14, 2015.

(51) Int. Cl. A23L 3/28; A23L 3/00

(52) U.S. Cl. CPC A23L 3/28; A23L 3/001; A23V 2002/00

(57) ABSTRACT

An apparatus for treating product, such as foodstuffs, has the product delivered to the surface of a rotating conveyor element. Without limitation, one form of the invention has a base that presents a generally planar top or upper surface, with a circular perimeter. This may take the form of a circular shaped table. Most preferably, the rotary table is made of glass or other transparent material. The rotary table conveys the foodstuffs within the field of one or more pulsed UV lights optionally arranged about the table to allow for exposure of the product to the light source. In one form, the light exposure is not only on the top surface, but also from the bottom or below the table.

### FIELD OF THE INVENTION

The present invention generally relates to food processing and packaging, and more particularly relates to a system incorporating a sanitization of the foodstuff using ultraviolet light, which further may be used for food enhancement.

### BACKGROUND OF THE INVENTION

Many foodstuffs are difficult to sanitize. Such foodstuffs include but are not limited to spices, powders, flours, fruits, grains, vegetables, poultry, and fish. In the handling of many foodstuffs, it is a recognized method of food safety to subject the product to ultraviolet (UV) light. This may be considered a sanitization procedure in many respects. The UV light, when applied properly, is capable of reducing, if not substantially neutralizing, certain pathogens and other deleterious materials and substances that may be on the outside of the product. In some instances, the UV light may further pass through the surface of the product and into the product, depending on the nature of the product, and whether such interior treatment is desired.

Pulsed UV light is a known way to treat foodstuffs (“product”) in the foregoing manner. The UV light is pulsed in part to increase the effective amount of energy applied to the product at one time, yet reducing the dwell time of the UV light so as to not to harm the product through overexposure, or at least to minimize collateral deleterious effects from exposure to the UV light.

Pulsed UV light is generally applied from a high intensity light source. An example of the foregoing light is manufactured and sold by Xenon Corporation of Wilmington, Mass. This example of pulsed UV light is acknowledged by the Food & Drug Administration as an intervention technology for sanitization.

Separate from its sanitizing aspects, another effect of this pulsed UV light treatment is enhancement of vitamin D in mushrooms, and an increase in antioxidants in products such as blueberries.

### SUMMARY OF THE DISCLOSURE

Cougar Packaging Concepts, Inc. has created a system to sanitize foodstuffs by subjecting the product to pulsed UV light. To that end, in an earlier application, a linear conveyor has been used to carry the foodstuffs to a pulsed UV light station or tunnel with pulsed UV lights for sanitization. The speed of the conveyor belt and operation of the pulsed lights sources is appropriately controlled as by a computer processor operated system. More details of the foregoing system and product can be gleaned from WO 2014/089456, filed Dec. 6, 2013.

An improvement on the foregoing system and apparatus is to deliver the foodstuffs to be treated to a pulsed UV light station on a rotary surface or table. More particularly, the present invention in one preferred form uses a rotating base having a surface made of a transparent material, such as glass. Most preferably, the material of the base, or turntable, could be clear quartz. The foodstuff material is delivered to the top of the turntable, and spread upon the surface. Being transparent, treatment of the material can be effected from exposure from the top as well as the bottom of the turntable.

The speed of rotation can be controlled to provide the desired exposure, or dwell time, for the material. A rotating table has the additional benefit of providing a more compact apparatus, as compared to a linear conveyor for example.

In one aspect of the invention, foodstuffs to be treated with UV light are placed in a supply. The supply may preferably be a chute or hopper such that the speed and/or volume of release of the foodstuffs from the bottom of the supply may be appropriately controlled.

The foodstuffs (product) are then delivered to the surface of a rotating conveyor element. Without limitation, one form of the invention has a base that presents a generally planar top or upper surface, with a circular perimeter. This may take the form of a circular shaped table, for example. Most preferably, the rotary table is made of glass or other transparent material, such as quartz glass or tempered glass. The rotary table may optionally include vibrational aspects or elements to agitate the material being treated, as well as spread the material over the surface. The rotary table conveys or passes the foodstuffs within the field of one or more pulsed UV lights optionally arranged about the table to allow for exposure of the product to the light source(s). Most preferably, the light exposure is not only on the top surface, but also from the bottom or below the table. This can be accomplished using reflectors located on a side of the table opposite that of the light source, or through light sources above and below the table.

In one form of the invention, the sanitized material is then removed from the table, as through the use of a divider or wiper, which engages the table upper surface to catch and then direct the sanitized material to an exit point. The treated material then may pass to a container, chute or to a further conveyor for additional processing, such as packaging.

In another aspect of the invention, one or more pulsed UV lights atop a movable table are removably positioned about the horizontal top surface of the conveyor, preferably both the horizontal top and bottom surfaces of the conveyor.

It will be understood that the use of the phrase “table” or “turntable” is intended to be non-limiting. It is considered to be an apt description herein, as the material to be treated is more or less set upon the table surface, and the conveyor element itself in a present form is table-like in appearance.

These and other aspects, advantages, applications and features of the invention will be better understood upon consideration of the following detailed description, taken in conjunction with the drawings, in which:

### BRIEF DESCRIPTION OF THE DRAWINGS

FIG. 1 is a perspective view of one embodiment of the inventive pulsed light treatment system with rotary light table application;

FIG. 2 is a top view of the embodiment of FIGS. 1; and

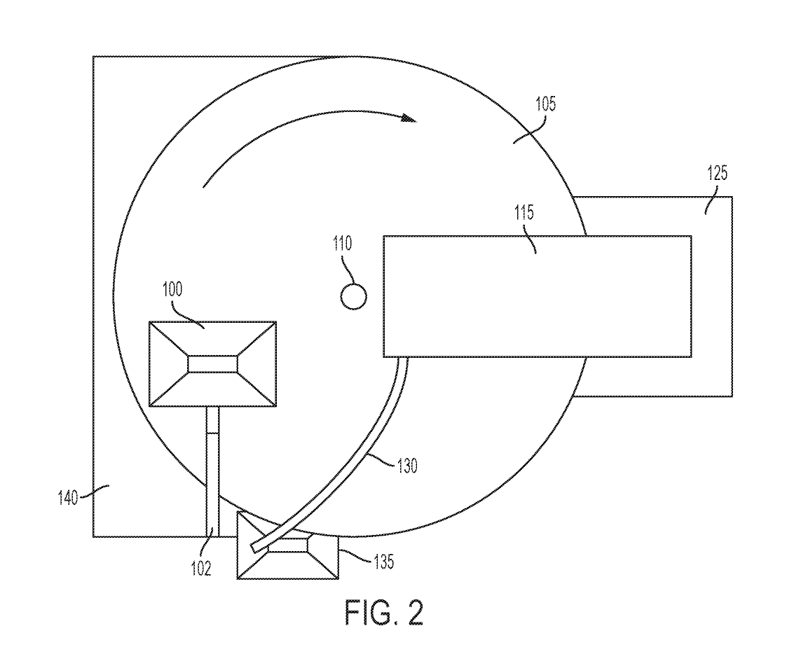

FIG. 3 is a side elevational view of the embodiment of FIG. 1.

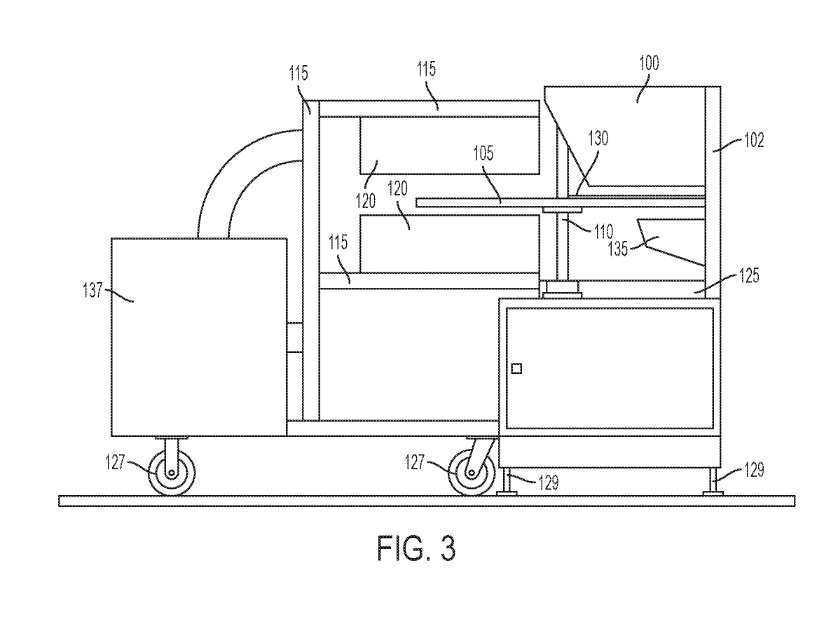

### DETAILED DESCRIPTION OF AN EMBODIMENT

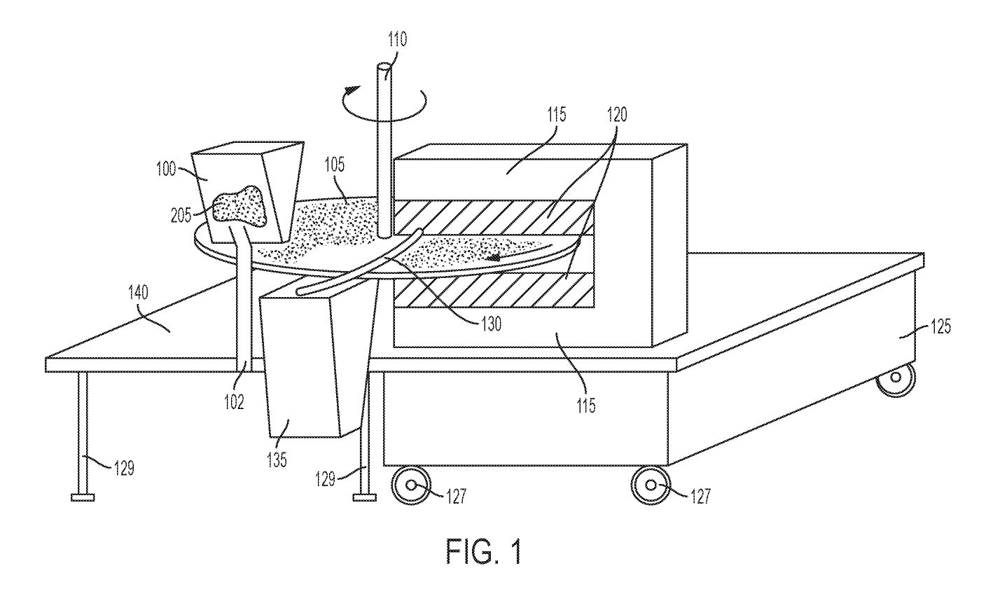

FIG. 1 shows in perspective form an embodiment of the inventive light treatment system with a rotary light table, as for treating a foodstuff. Of course, the invention is not limited to any particular foodstuff, but is applicable to many different kinds of foodstuffs and products, whether fruit, meat, fish, confection, and so on. Conceptually, the inventive light treatment system with light table application is useful for non-foodstuffs, where the material or product is intended to be treated by a light source, or even some other kind of radiant energy. It has found commercial application in the present instance in the form of an apparatus for treating a foodstuff, however, and is therefore described herein in the context of that environment. Further, while applied in this embodiment for treating the foodstuff to reduce contamination and promote shelf-life, so as to sanitize the product for safe human consumption, the treatment could be to some other end. As noted above, for instance, the apparatus can be used to produce salutary effects in the material, such as enhanced Vitamin D in mushroom produce.

In one embodiment, a foodstuff or product is loaded into a supply 100. The supply 100 may preferably be a chute, hopper, or bin such that the speed and/or volume of release of the foodstuffs from the bottom of the supply 100 may be appropriately controlled. The manner in which the product is supplied may be of many known types. The foodstuffs, such as blueberries 205, are delivered from the bottom of the supply 100 to the upper surface of a rotary conveyor 105, described herein as a turntable, or simply a table. The table 105 is made of glass, which may be quartz glass or some other transparent material, such as tempered glass. A rigid table is desired, so that it may support its own weight when mounted or suspended from a central axis. However, one can envision supports, such as rollers, upon which the table 105 could rest, thereby extending its radius or providing a thinner table, or both.

Here, the table 105 is mounted for rotation by operation of a motor connected to a vertical spindle 110 at the center of the table 105. The table 105 and spindle 110 assembly may be fastened atop an optionally movable chassis 140, with a motor drive compartment contained therein. The motor drive mechanism itself can be of many known types, designed to rotate the spindle 110 and thereby turn the table 105. For example, the motor drive can be any constant or variable speed motor, a gas or electric motor (such as a brushed, brushless, or stepper motor, or any other alternate current (AC) or direct current (DC) motor), or any other type of motor. In some embodiments, the motor drive is a 90 or 180 V DC permanent magnet motor. As will be discussed, a controller may be used to set the speed (rpm) of the table relative to the amount of dwell time, or exposure, desired for the product being treated. The controller may be programmable, or could simply be selection of a desired speed of rotation input to the motor drive. Material dropped from the hopper 205 is also timed to match the speed chosen for the table rotation speed. This timing may be integrated with the controller, or could be set independently of the drive motor.

The foodstuffs 205 deposited on the table upper surface then progress with the table as it turns, ultimately within the range of a UV light station consisting of one or more pulsed UV light(s) 120 mounted in a light housing 115. The pulsed UV light(s) 120 used here have reflectors and are positioned above the horizontal surface of the table 105, preferably both the horizontal top and bottom surfaces of the conveyor 105. That is, reflectors can be used not only to concentrate the spread of the light, but also to reflect light passing through the upper surface of the table via reflectors below the table, returning the light back upwardly, and thus to the bottom surface of the foodstuffs. So too, a set of UV lights may be used to illuminate the bottom of the table in addition to the upper set.

The housing 115 may be fastened atop a light application table 125, preferably equipped with casters or wheels to removably position the light housing 115 and pulsed UV light(s) 120 therein.

In this embodiment, pulsed UV light(s) 120 are arranged in suitable number, power (lumens) and at appropriate distances to sanitize or otherwise treat the foodstuffs to the desired amount. Without limitation, in this embodiment, pulsed UV light(s) 120 may preferably emit broadband radiation consisting of wavelengths covering the range of 200 to 1000 nanometers (nm), and may be operated so that the pulse duration is preferably about than 2 milliseconds (ms), as approved by the United States Food and Drug Administration for the use of pulsed UV light in the Production, Processing, and Handling of Food, 21 C.F.R. §179.41. The UV lights used in this embodiment can be xenon pulsed UV lights, for example, similar to those used in the curing of industrial adhesives or ink. These pulsed UV lights can emit a high-intensity, low-heat beam periodically, for example, every 10 ms. The exposure pulse will be adjusted based upon the kind of product, the desired level of treatment, and the production rate, to name three significant factors to take into consideration.

Note that a pulsed light exposure is considered particularly desirable. However, a steady exposure might be appropriate in certain circumstances. The source or type of radiant energy could also be modified to suit other circumstances. In general, the concept is to provide a rotary surface upon which material is deposited, the material then traversing a source of energy (light, other electromagnetic energy, etc.) in a desired exposure rate, and then having the treated material discharged from the surface of the rotary element, all as the surface rotates about an axis.

The speed of the table 105 and operation of the pulsed UV light(s) 120 in one embodiment are appropriately controlled by a computer processor system. This system uses programmable logic control to control the electromechanical attributes of the system, such as the motor. For example, the speed of the table 105 and operation of the pulsed UV light(s) 120 can be determined by programmed software stored in a memory and executable by a processor to selectively perform a desired operation when a user so commands.

It will be noted that an additional benefit of fabricating the table 105 from glass is that using reflectors or reflective surfaces may maximize the benefits of the pulsed UV light. Appropriate shielding may be used to protect workers from the pulsed UV light(s) 120. The system may have a ventilation component for removing ozone gas that may be a byproduct of the light treatment. The table 105 may additionally be provided with an apparatus to agitate the product, so as to expose all sides of the product to the pulsed UV light(s) 120. This could be a shaker, blower or the like, so as to move the material as it traverses with the table.

Having been effectively treated with the pulsed UV light(s) 120, the foodstuffs then progress in the table rotation to an angled divider or wiper 130, which removes product by directing the material toward the outer edge of the table 105 along the front surface of the wiper 130. The wiper 130 may preferably have a somewhat flexible part which engages with the upper surface of the table 105, such as a rubber or plastic edge. At the outer edge of the wiper 130, the foodstuffs accumulate and fall off the surface of the table 105 into a receiving container 135, preferably through a discharge chute. Other arrangements for getting the UV-treated foodstuffs from the system to a subsequent station are well known and understood to those of skill.

The present invention is thus considered to yield a pulsed light treatment system with a relatively compact arrangement in the form of a rotating light table, as for treating foodstuffs and products so as to sanitize them by exposing them to pulsed UV light sources, in one application of the invention. While the invention has been described with respect to a particular embodiment(s), and application in a specific environment, those of skill will recognize modifications of components, elements, materials, arrangements, and the like which will still fall within the spirit and scope of the invention, and the invention is not to be limited to such embodiment(s) or specific details.

What is claimed is:

1. A system for treating foodstuffs, comprising:
a supply for foodstuffs to be treated;
a rotary conveyor communicating with said supply whereby foodstuffs are deposited from said supply upon an upper surface of said rotary conveyor;
a treatment station through which said rotary conveyor surface passes having an energy source to which the foodstuffs are exposed for treatment;
an element which engages the foodstuffs subsequent to said treatment station to direct the foodstuffs off of the upper surface.

2. An apparatus for treating loose material by exposure to pulsed light, comprising:
a supply for loose material to be treated;
a rotatable base having a surface upon which the loose material is deposited from said supply;
motor drive for turning said rotatable base on an axis;
light source mounted to expose at least part of said surface to a pulsed light; and
member which engages the loose material to remove the loose material from the surface subsequent to passage by said light source.

3. The apparatus of claim 1, wherein the base is a rotary turntable.

4. The apparatus of claim 2, wherein the turntable is transparent to light from said light source, and including a reflector device on an opposite side of said turntable relative to said light source to reflect light passing through said turntable back through said turntable to the loose material.

5. The apparatus of claim 4, wherein the turntable is made of quartz glass or tempered glass.

6. The apparatus of claim 1, wherein the said light source is positioned over only a portion of said surface to illuminate a discrete area of said surface as said base rotates.

7. The apparatus of claim 3, wherein said light source comprises a first light source located above said turntable and a second light source located below said turntable.

8. The apparatus of claim 6, wherein the light source is a pulsed UV light which emits broadband radiation consisting of wavelengths within the range of 200 to 1000 nanometers, and with pulse durations of about 2 milliseconds.

9. A system for treating foodstuffs, comprising:
a supply of foodstuffs to be treated;
a rotary base having a surface upon which foodstuffs are deposited from said supply, said base being transparent to light;
a motor drive for rotating said base;
a sanitizing station through which foodstuffs are progressed, said sanitizing station having one or more pulsed UV light(s) mounted spaced from one side of said station to illuminate a part of said surface to an extent to provide a sanitizing effect on the foodstuffs as the foodstuffs pass through said sanitizing station atop said surface;
a reflector located to reflect light passing through said base back through said base to said surface; and
an element which engages the foodstuffs to remove foodstuffs from the conveyor after the foodstuffs have progressed through the sanitizing station, said element cooperating with the rotating base to direct the foodstuffs toward the outer edge of the surface and to an exit point.
